(19) United States
(12) Patent Application Publication
(10) Pub. No.: US 2016/0216975 A1
(43) Pub. Date: Jul. 28, 2016

(54) OPERATION TERMINAL AND INFORMATION PROCESSING SYSTEM

(71) Applicant: Takahiro HASHIMOTO, Kanagawa (JP)

(72) Inventor: Takahiro HASHIMOTO, Kanagawa (JP)

(73) Assignee: RICOH COMPANY, LTD., Tokyo (JP)

(21) Appl. No.: 14/966,073

(22) Filed: Dec. 11, 2015

(30) Foreign Application Priority Data
Jan. 26, 2015 (JP) 2015-012560

(51) Int. Cl. G06F 9/44; G06F 9/48

(52) U.S. Cl. CPC G06F 9/441; G06F 9/4818

(57) ABSTRACT

An operation terminal is provided that starts an application selected by a user from among a plurality of applications installed therein. The operation terminal includes an electronic data list acquiring unit that acquires from an information storage apparatus, a list of electronic data items stored in the information storage apparatus and priority application information of a priority application associated with each of the electronic data items; a display unit that displays an operation screen including the list of electronic data items and a startup accepting unit provided with respect to each of the electronic data items for accepting from the user a startup request for the priority application associated with a relevant electronic data item; and a starting unit that selects the relevant electronic data item that is associated with the priority application for which the startup request has been accepted from the user and start the priority application.

### BACKGROUND OF THE INVENTION

1. Field of the Invention

The present invention relates to an operation terminal and an information processing system.

2. Description of the Related Art

Recently, with the increase in the number of devices connected to a network and improvement of network communication speed, for example, the amount of data stored in a network storage such as NAS (Network Attached Storage) is increasing. Thus, an application that accesses the network storage and presents the stored data to a user is typically configured to sort the stored data in chronological order according to their update date/time, for example.

Also, techniques are known for enabling a user to easily find an icon corresponding to a target application from among icons of a plurality of applications displayed on a screen of a smart device such as a smartphone or a tablet terminal. For example, a technique is known for enabling a user to easily find an icon corresponding to a target application by changing the display size and/or display mode of icons depending on how frequently the icons are selected and the time elapsed from the last access date/time of the corresponding applications (e.g., see Japanese Laid-Open Patent Publication No. 2013-161412).

A file stored in a network storage may be opened from a smartphone or a tablet terminal using a relevant application that is installed in the smartphone or tablet terminal, for example. However, it is quite troublesome to select the file from among a plurality of files stored in the network storage using the relevant application that has to be selected from a plurality of applications that are installed in the smartphone or tablet terminal.

### SUMMARY OF THE INVENTION

An aspect of the present invention is directed to providing an operation terminal that is capable of facilitating use of a desired file stored in an information storage apparatus using a desired application.

According to one embodiment of the present invention, an operation terminal is provided that has a plurality of applications installed therein and is configured to start an application that has been selected by a user from among the plurality of applications. The operation terminal includes an electronic data list acquiring unit configured to acquire from an information storage apparatus, a list of electronic data items stored in the information storage apparatus and priority application information of a priority application associated with each of the electronic data items included in the list; a display unit configured to display, based on the list of electronic data items and the priority application information acquired by the electronic data list acquiring unit, an operation screen including the list of electronic data items and a startup accepting unit provided with respect to each of the electronic data items included in the list, the startup accepting unit being configured to accept from the user a startup request for starting the priority application that is associated with a relevant electronic data item of the electronic data items included in the list; and a starting unit configured to select the relevant electronic data item that is associated with the priority application for which the startup request has been accepted from the user by the startup accepting unit and start the priority application.

### BRIEF DESCRIPTION OF THE DRAWINGS

FIG. 1 is a block diagram illustrating an information processing system according to an embodiment of the present invention;

FIG. 2 is a block diagram illustrating an exemplary hardware configuration of a computer according to an embodiment of the present invention;

FIG. 3 is a block diagram illustrating an exemplary hardware configuration of an operation terminal according to an embodiment of the present invention;

FIG. 4 is a block diagram illustrating an exemplary hardware configuration of a multifunction peripheral according to an embodiment of the present invention;

FIG. 5 is a block diagram illustrating an exemplary functional configuration of an information storage apparatus according an embodiment of the present invention;

FIG. 6 is a block diagram illustrating functional units implemented by a widget in the operation terminal;

FIG. 7 illustrates an example of an operation screen displayed by the operation terminal;

FIG. 8 is a flowchart illustrating an exemplary process for starting an app from a widget screen;

FIG. 9 is a table illustrating an exemplary configuration of priority app management information;

FIG. 10 is a table illustrating an exemplary configuration of file list information including priority app information;

FIG. 11 illustrates an example of a new app registration screen;

FIG. 12 is a flowchart illustrating an exemplary process for switching the widget screen displayed in an operation screen;

FIG. 13 illustrates another example of an operation screen displayed by the operation terminal;

FIG. 14 illustrates another example of an operation screen displayed by the operation terminal;

FIG. 15 illustrates an example of application buttons displayed in the widget screen;

FIG. 16 is a flowchart illustrating another exemplary process for starting an app from the widget screen;

FIG. 17 is a table illustrating another exemplary configuration of the priority app management information;

FIG. 18 is a table illustrating another exemplary configuration of the file list information including first, second, and third priority app information; and

FIG. 19 is a table indicating exemplary file input methods in association with apps.

### DESCRIPTION OF THE PREFERRED EMBODIMENTS

In the following, embodiments of the present invention are described with reference to the accompanying drawings.

### First Embodiment

<System Configuration>

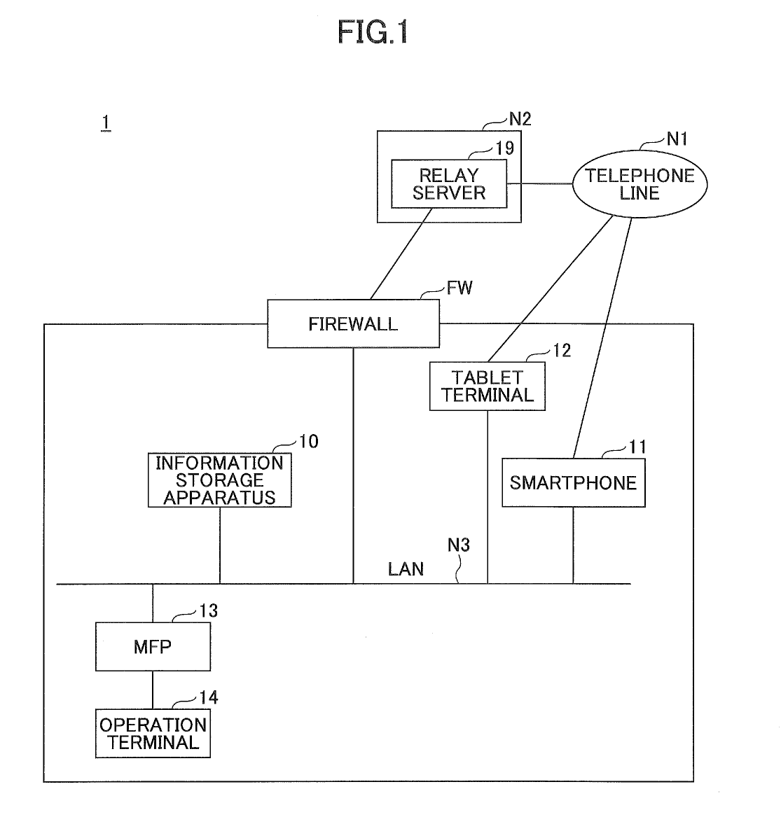

FIG. 1 is a block diagram illustrating an exemplary configuration of an information processing system 1 according to a first embodiment of the present invention. In FIG. 1, the information processing system 1 includes an information storage apparatus 10, a smartphone 11, a tablet terminal 12, an MFP (Multi-Function Peripheral) 13, and an operation terminal 14.

In the information processing system 1, the information storage apparatus 10, the smartphone 11, the tablet terminal 12, and the MFP 13 are interconnected via a network N3 such as a LAN (Local Area Network). Also, an operation terminal 14 for accepting an operation from a user is connected to the MFP 13. The operation terminal 14 may be arranged inside the housing of the MFP 13, or the operation terminal 14 may be a separate unit arranged outside the housing of the MFP 13.

The network N3 is connected to a relay server 19 via a firewall FW and a network N2 such as the Internet or a WAN (Wide Area Network), for example. The smartphone 11 and the tablet terminal 12 may establish connection with the relay server 19 via a network N1 such as a telephone line.

The information storage apparatus 10 has a file server function. The information storage apparatus 10 may have the capacity to perform advanced processing that cannot be performed by the MFP 13 (e.g., converting a file format). The information storage apparatus 10 may be configured by multiple computers or a single computer, for example.

The MFP 13 of the information processing system 1 illustrated in FIG. 1 is an example of an electronic device having an application installed therein for opening a file acquired from the information storage apparatus 10 and performing a process thereon. The MFP 13 may have an image capturing function, an image forming function, and a communication function, and may function as a printer, a facsimile, a scanner, or a copying machine, for example. Note that although only one MFP 13 is illustrated in the information processing system 1 of FIG. 1, the information processing system 1 may include a plurality of MFPs 13.

The smartphone 11 and the tablet terminal 12 of the information processing system 1 illustrated in FIG. 1 are examples of operation terminals that are operated by a user. Note that other examples of an operation terminal that is operated by a user include a mobile phone and a PC (personal computer). The smartphone 11 and the tablet terminal 12 may be connected to the networks N1 and N3. The network N1 is capable of using a telephone line such as a 3G network.

The smartphone 11 and the tablet terminal 12 are capable of establishing connection with the information storage apparatus 10 and the MFP 13, for example, via the network N1 and the relay server 19. Also, the smartphone 11 and the tablet terminal 12 are capable of establishing connection with the information storage apparatus 10 and the MFP 13 via the network N3.

The operation terminal 14 is another example of an operation terminal and has functions similar to those of the tablet terminal 12. The operation terminal 14 is capable of establishing connection with the information storage apparatus 10 via the MFP 13. Note that the operation terminal 14 may also be capable of establishing connection with the information storage apparatus 10 without being connected to the MFP 13, for example.

The relay server 19 acts as an intermediary for the smartphone 11 and the tablet terminal 12 to establish connection with the information storage apparatus 10 and the MFP 13, and in this way, the smartphone 11 and the tablet terminal 12 may use the information storage apparatus 10 and the MFP 13 from the network N2. Note that known techniques may be used to establish connection with the information storage apparatus 10 that is within the firewall FW from outside the firewall FW via the relay server 19.

Note that the configuration of the information processing system 1 illustrated in FIG. 1 is merely one example and is not intended to limit the scope of the present invention. For example, in other configurations, the relay server 19 may be omitted, the firewall FW may be omitted, and/or the information processing system 1 may include an electronic device other than the MFP 13 that can be connected to the operation terminal 14 such as a projector or an interactive whiteboard, for example. Also, in some other configurations, the information storage apparatus 10 may be outside the firewall FW (network N2 side).

<Hardware Configuration>

<<Computer>>

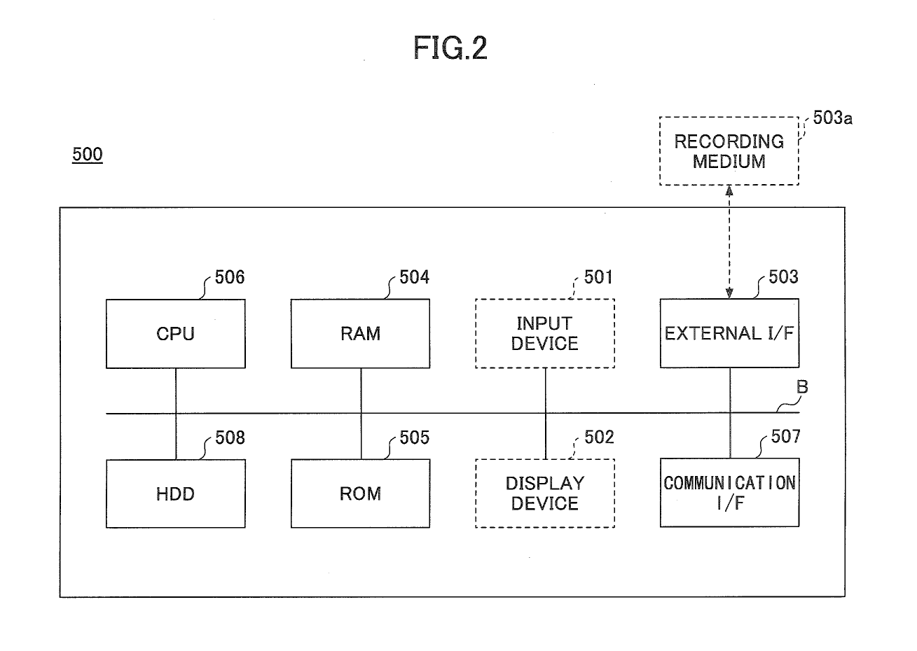

The information storage apparatus 10 and the relay server 19 may be implemented by a computer having a hardware configuration as illustrated in FIG. 2, for example. FIG. 2 is a block diagram illustrating an exemplary hardware configuration of a computer 500 according to an embodiment of the present invention.

In FIG. 2, the computer 500 includes an input device 501, a display device 502, an external I/F 503, a RAM 504, a ROM 505, a CPU 506, a communication I/F 507, and an HDD (hard disk drive) 508 that are interconnected via a bus B. Note that in some embodiments, the input device 501 and the display device 502 may be connected to the computer 500 when they need to be used, for example.

The input device 501 may include a keyboard, a mouse, and/or a touch panel, for example, and is operated by a user to input various operation signals to the computer 500. The display device 502 may include a display, for example, and is configured to display processing results of the computer 500.

The communication I/F 507 is an interface for connecting the computer 500 to various networks. The computer 500 may establish data communication with other computers via the communication I/F 507.

The HDD 508 is a nonvolatile storage device storing programs and data. The programs stored in the HDD 508 may include an operating system (OS) corresponding to basic software controlling overall operations of the computer 500, and application software (also simply referred to as “application” hereinafter) providing various functions under the control of the OS, for example. Note that in some embodiments, the computer 500 may include a drive apparatus such as a solid state drive (SSD) that uses a flash memory as a recording medium instead of the HDD 508.

The external I/F 503 is an interface between the computer 500 and an external device. The external device may be a recording medium 503a, for example. The computer 500 may read information from and/or write information on the recording medium 503a via the external I/F 503. Specific examples of the recording medium 503a include a flexible disk, a compact disk (CD), a digital versatile disk (DVD), a SD memory card, a universal serial bus (USB) memory, and the like.

The ROM 505 is a nonvolatile semiconductor memory (storage device) that can store programs and/or data even when the power is turned off. The ROM 505 may store programs and data such as a basic input/output system (BIOS) to be performed when the computer 500 is started, OS settings, network settings, and the like. The RAM 504 is a volatile semiconductor memory (storage device) that temporarily stores programs and/or data.

The CPU 506 includes a computing unit that reads a program and/or data from a storage device such as the ROM 505 and/or the HDD 508, loads the program and/or data in the RAM 504, and executes processes according to the program and/or data to control the overall operations and functions of the computer 500.

The information storage apparatus 10 and the relay server 19 may implement various processes as described below using the hardware configuration of the computer 500 as illustrated in FIG. 2, for example.

<<Operation Terminal>>

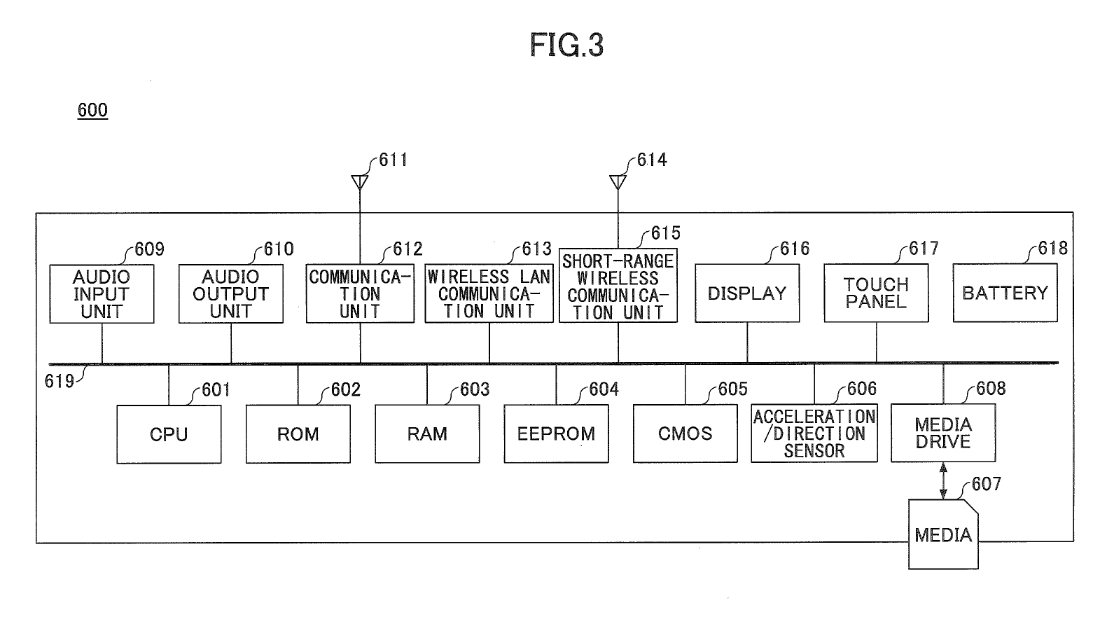

The smartphone 10, the tablet terminal 12, and the operation terminal 14 may be implemented by a terminal apparatus 600 having a hardware configuration as illustrated in FIG. 3, for example. FIG. 3 is a block diagram illustrating an exemplary hardware configuration of the terminal apparatus 600 according to an embodiment of the present invention. In FIG. 3, the terminal apparatus 600 includes a CPU 601, a ROM 602, a RAM 603, an EEPROM (Electrically Erasable Read Only Memory) 604, a CMOS (complementary metal-oxide semiconductor) sensor 605, an acceleration/direction sensor 606, and a media drive 608.

The CPU 601 controls overall operations of the terminal apparatus 600. The ROM 602 stores basic input/output programs. The RAM 603 is used as a work area of the CPU 601. The EEPROM 604 reads and writes data according to control of the CPU 601. The CMOS sensor 605 captures an image of an object and obtains image data of the object according to control by the CPU 601. The acceleration/direction sensor 606 may include an electromagnetic compass or a gyrocompass that detects terrestrial magnetism, and an acceleration sensor, for example.

The media drive 608 controls reading/writing (storing) of data with respect to recording media 607 such as a flash memory. The recording media 607 may be detachably loaded into the media drive 608 so that data recorded in the recording media 607 can be read from the recording media 607 and/or new data can be written (stored) in the recording media 607.

The EEPROM 604 may store an OS to be performed by the CPU 601 and required association information for setting up a network, for example. Note that applications for executing various processes according to the present embodiment may be stored in the EEPROM 604 or the recording media 607, for example.

The CMOS sensor 605 is an image sensor that converts light into an electrical charge to digitize an image of an object. The CMOS sensor 605 is not limited to a CMOS sensor but may be other types of image sensors such as a CCD (Charge Coupled Device) sensor as long as the sensor can capture an image of an object.

In FIG. 3, the terminal apparatus 600 further includes an audio input unit 609, an audio output unit 610, an antenna 611, a communication unit 612, a wireless LAN communication unit 613, a short-range wireless communication antenna 614, a short-range wireless communication unit 615, a display 616, a touch panel 617, and a bus line 619.

The audio input unit 609 converts audio into audio signals. The audio output unit 610 converts audio signals into audio. The communication unit 612 transmits/receives wireless signals to/from a nearest base station using the antenna 611. The wireless LAN communication unit 613 establishes wireless communication with an access point according to the IEEE80411 standard. The short-range wireless communication unit 615 establishes short-range wireless communication using the short-range wireless communication antenna 614.

The display 616 may be a liquid crystal display or an organic electro-luminescence display that displays an image of an object and various icons, for example. The touch panel 617 may be, for example, a pressure sensitive panel or an electrostatic panel arranged on the display 616 that detects a touch position on the display 616 touched by a finger, a pen, or the like, for example. The bus line 619 may be, for example, an address bus or a data bus for electrically connecting the aforementioned parts and components of the terminal apparatus 600.

The terminal apparatus 600 also includes a dedicated battery 618. The terminal apparatus 600 is driven by the battery 618. Note, also, that the audio input unit 609 includes a microphone into which audio is input. The audio output unit 610 includes a speaker from which audio is output.

The smartphone 10, the tablet terminal 12, and the operation terminal 14 of the present embodiment may implement various processes described below using the hardware configuration of the terminal apparatus 600 as illustrated in FIG. 3, for example.

<<Electronic Device>>

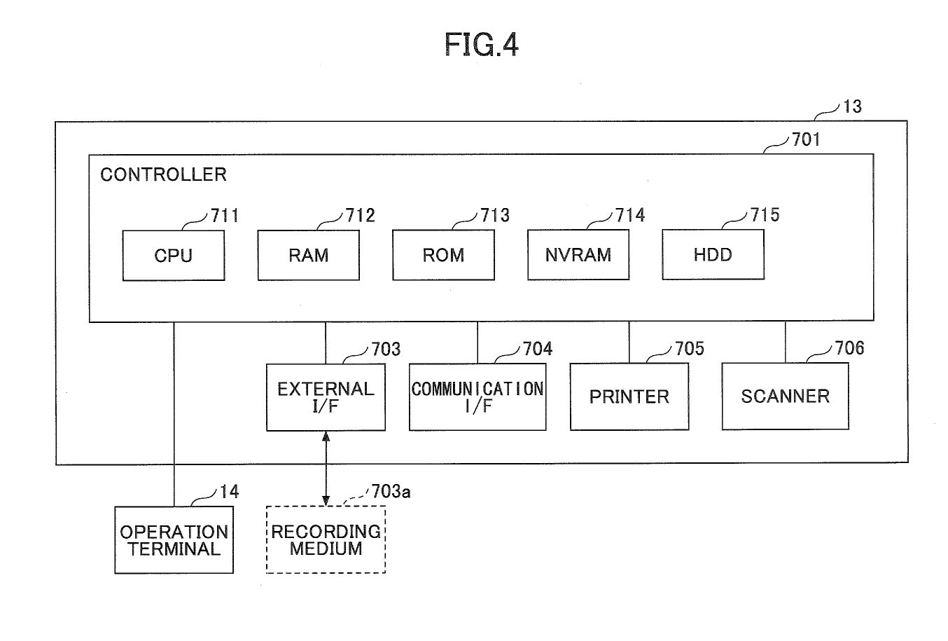

In the following, an exemplary hardware configuration of the MFP 13 as an example of an electronic device is described. FIG. 4 is a block diagram illustrating an exemplary hardware configuration of the MFP 13 according to the present embodiment. In FIG. 4, the MFP 13 includes a controller 701, an external I/F 703, a communication I/F 704, a printer 705, and a scanner 706.

The controller 701 includes a CPU 711, a RAM 712, a ROM 713, an NVRAM (non-volatile RAM) 714, and an HDD 715. The ROM 713 stores various programs and data. The RAM 712 temporarily stores programs and data. The NVRAM 714 may store setting information and the like. The HDD 715 stores various programs and data.

The CPU 711 controls the overall operations and functions of the MFP 13 by reading programs, data, and/or setting information from the ROM 713, the NVRAM 714, and/or the HDD 715, loading the program and data in the RAM 712, and executing various processes, for example. Note that the controller 701 may be connected to the operation terminal 14 wirelessly or via a cable to enable data communication with the operation terminal 14. The operation terminal 14 functions as an input unit for accepting from a user an input operation with respect to the MFP 13 and a display unit for displaying information to the user.

The external I/F 703 is an interface with an external device. The external device may be a recording medium 703a, for example. In this way, the MFP 13 may read/write data from/on the recording medium 703a via the external I/F 703. Note that specific examples of the recording medium 703a includes an IC card, a flexible disk, a CD, a DVD, an SD memory card, a USB memory, and the like.

The communication I/F 704 is an interface that connects the MFP 13 to the network N3. In this way, the MFP 13 may establish data communication with an external apparatus via the communication I/F 704. For example, the MFP 13 may establish data communication with the smartphone 11 and the tablet terminal 12 via the communication I/F 704. Note that the smartphone 11 and the tablet terminal 12 may also function as an input unit for accepting an input operation from the user and a display unit for displaying information to the user.

Note that although the operation terminal 14 is arranged outside the housing of the MFP 13 in the example illustrated in FIG. 4, in some embodiments, the operating terminal 14 may be arranged within the housing of the MFP 13, for example. The printer 705 is a printing device for printing print data on a printing medium such as paper. The scanner 706 is a device for scanning image data (electronic data) from a document.

The MFP 13 may implement various processes described below using the hardware configuration as illustrated in FIG. 4, for example.

<Software Configuration>

<<Information Storage Apparatus>>

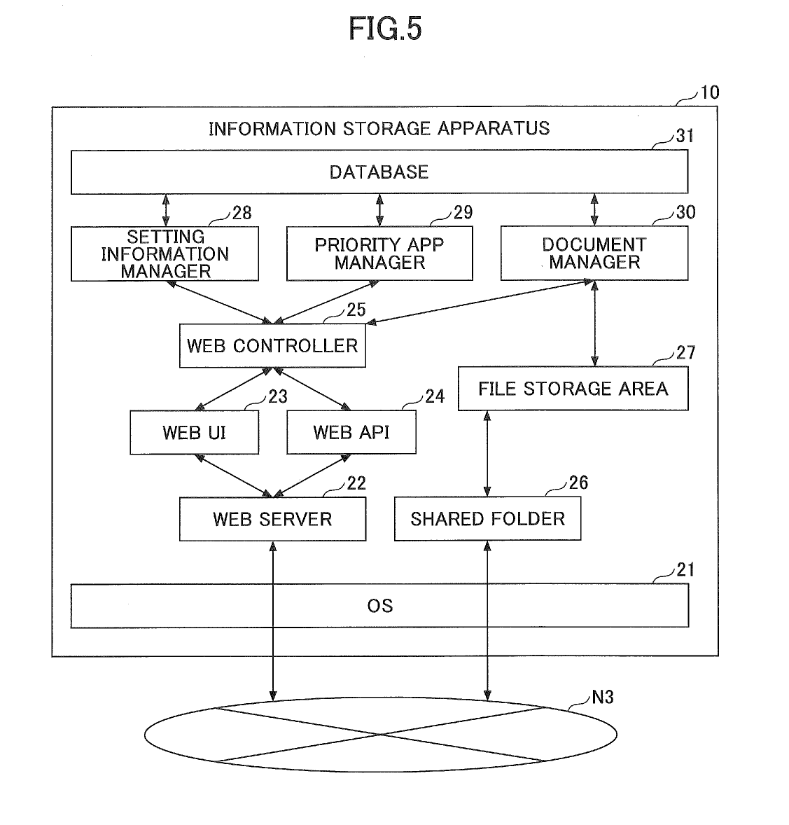

The information storage apparatus 10 according to the present embodiment may include functional units (or processing blocks) as illustrated in FIG. 5, for example. FIG. 5 is a block diagram illustrating an exemplary functional configuration of the information storage apparatus 10. The information storage apparatus 10 executes a relevant program installed therein to implement an OS 21, a web server 22, a web UI 23, a web API 24, a web controller 25, a shared folder 26, a file storage area 27, a setting information manager 28, a priority app manager 29, a document manager 30, and a database (DB) 31.

The OS 21 is an operating system for controlling the overall operations and functions of the information storage apparatus 10. The OS 21 may be implemented by, for example, Windows (registered trademark) or Linux (registered trademark).

The web server 22 is software for sending and receiving information via the Hypertext Transfer Protocol (HTTP). The web server 22 may be implemented by, for example, Apache (registered trademark) or IIS (registered trademark).

The web UI 23 displays a screen such as a system setting screen or a user setting screen in response to an HTTP request. For example, the web UI 23 allows a user to change settings using a web browser (not shown).

The web API (application programming interface) 24 is available via the network N1. The web API 24 receives an HTTP request, performs a process corresponding to the received HTTP request, and returns an HTTP response. That is, the web API 24 is a predefined interface for receiving requests from the operation terminal 14, for example, and may be implemented by functions or classes. The web controller 25 performs processes for controlling the setting information manager 28, the priority app manager 29, and the document manager 30 according to requests from the web UI 23 and the web API 24, for example.

The shared folder 26 is a folder that is made public on the networks N2 and N3 via the Server Message Block (SMB) protocol. A user can access the shared folder 26 using the smartphone 11, the tablet terminal 12, or the operation terminal 14, for example. The file storage area 27 corresponds to an area where a file is actually stored.

The setting information manager 28 may store setting information in the database 31, or read setting information from the database 31 according to a request from the web controller 25, for example. The priority app manager 29 manages information such as a usage track record and/or a usage frequency of apps with respect to each file. The document manager 30 manages files stored in the file storage area 27 and performs various processes such as a file conversion process according to a request from the web controller 25.

Note that a file in the present embodiment is an exemplary form of electronic data. Also, the information storage apparatus 10 may include a functional unit (processing block) for executing a process for accessing the relay server 19 to acquire a request from the smartphone 11 or the tablet terminal 12, for example.

<<Operation Terminal>>

The operation terminal 14 according to the present embodiment has a widget installed therein. A widget is a generic term for an application that implements a specific function on a screen, and is one form of an application installed in the operation terminal 14 (also referred to as “app” hereinafter). The widget installed in the operation terminal 14 according to the present embodiment corresponds to an app for enabling a user to easily select a file stored in the information storage apparatus 10 and start a relevant app for opening the selected file.

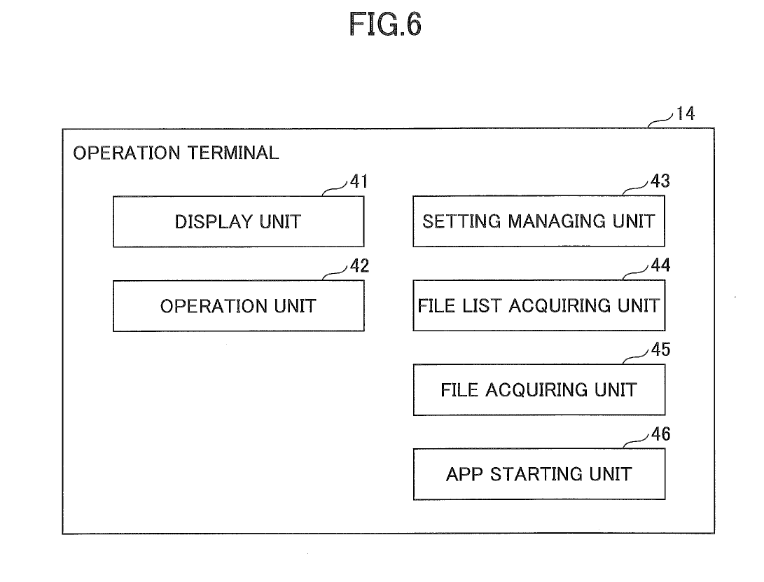

The operation terminal 14 according to the present embodiment may have a widget installed therein for implementing functional units (processing blocks) as illustrated in FIG. 6, for example. FIG. 6 is a block diagram illustrating exemplary functional units (processing blocks) implemented by the widget installed in the operation terminal 14.

Note that in FIG. 6, processing blocks that are not relevant to aspects of the present embodiment described below are omitted. The operation terminal 14 may execute the widget installed therein to implement a display unit 41, an operation unit 42, a setting managing unit 43, a file list acquiring unit 44, a file acquiring unit 45, and an app starting unit 46.

The display unit 41 displays information to the user. For example, the display unit 41 may display a list of files stored in the information storage apparatus 10. The operation unit 42 accepts various operations from the user. For example, as described below, the operation unit 42 may accept in one operation, a selection of a desired file stored in the information storage apparatus 10 and a selection of a desired app to be started in conjunction with the selection of the desired file.

The setting managing unit 43 manages various settings such as an ID of the information storage apparatus 10 and a user ID. The file list acquiring unit 44 acquires a list (file list) of files stored in the information storage apparatus 10. The file acquiring unit 45 acquires a file stored in the information storage apparatus 10.

In response to a selection of a desired file and a selection of a desired app accepted from a user in a single operation by the operation unit 42 (described below), the app starting unit 46 starts the selected app in conjunction with the selection of the desired file. Note that the smartphone 11 and the tablet terminal 12 may also be configured to implement the functional units (processing blocks) of the operation terminal 14 as illustrated in FIG. 6.

<Processes>

In the following, processes of the information processing system 1 according to the present embodiment are described. Note that although an exemplary operation screen of the operation terminal 14 is described below, similar operation screens may be implemented in the smartphone 11 and the tablet terminal 12, for example.

<<Operation Screen of Operation Terminal>>

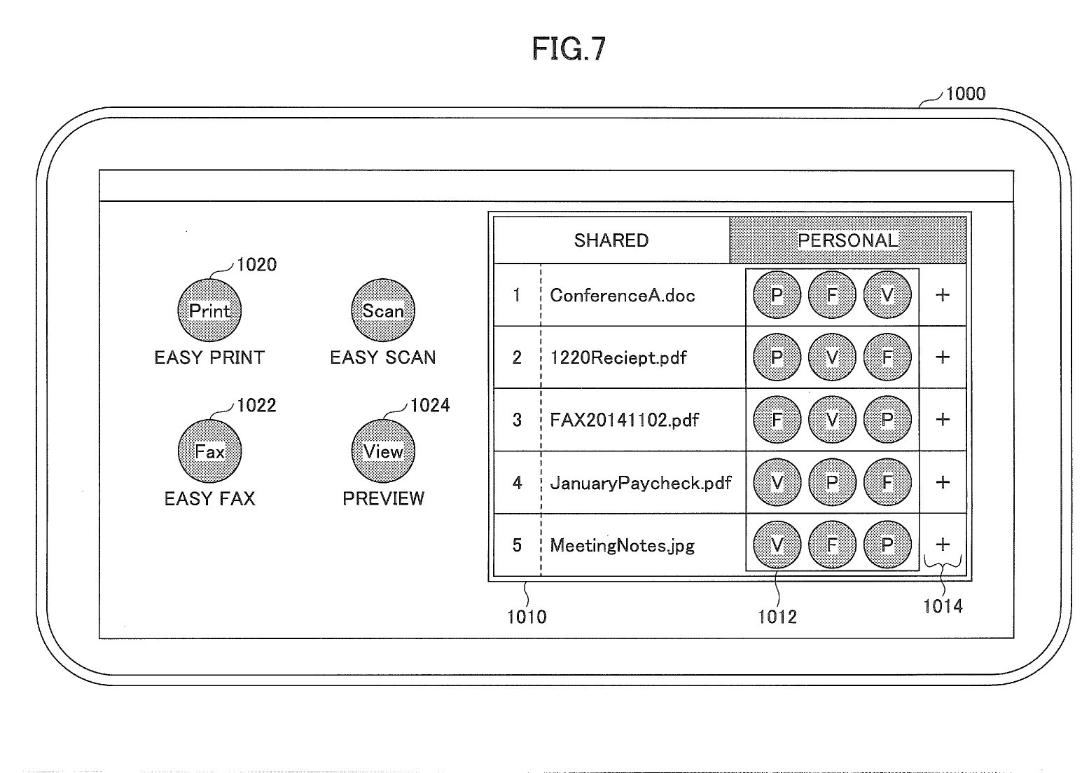

The operation terminal 14 may display an operation screen as illustrated in FIG. 7, for example. FIG. 7 is an image of an exemplary operation screen 1000 displayed by the operation terminal 14. The operation screen 1000 illustrated in FIG. 7 includes a widget screen 1010 displayed by a widget.

The widget screen 1010 of FIG. 7 displays a list of files stored in the information storage apparatus 10, app buttons 1012 for starting apps provided with respect to each file, and “+” buttons 1014 for adding an app button 1012.

The list of files displayed in the widget screen 1010 may have files stored in the information storage apparatus 10 arranged in descending order (newest to oldest) according to their update date/time, for example. Note, however, that the list of files displayed in the widget screen 1010 is not limited to being arranged according to their update date/time but may be listed in any order that enables the user to easily select a desired file.

Also, the app buttons 1012 displayed in association with each file in the widget screen 1010 correspond to apps that have previously been used with respect to the corresponding file. Note that the app button 1012 “P” in the widget screen 1010 of FIG. 7 corresponds to an “easy print” app that may be started when a “print” button 1020 displayed in the operation screen 1000 is pressed.

Also, the app button 1012 “F” in the widget screen 1010 of FIG. 7 corresponds to an “easy fax” app that may be started when a “fax” button 1022 displayed in the operation screen 1000 is pressed.

The app button 1012 “V” in the widget screen 1010 of FIG. 7 corresponds to a “preview” app that may be started when a “view” button 1024 displayed in the operation screen 1000 is pressed.

For example, when the “print” button 1020 in the operation screen 1000 is pressed to start the “easy print” app, the user has to select a file after the “easy print” app has been started.

On the other hand, for example, when the app button 1012 “P” in the widget screen 1010 is pressed to start the “easy print” app, the file associated with the app button 1012 “P” may already be selected when the “easy print” app is started. In this way, in the operation terminal 14 according to the present embodiment, one single operation of pressing the app button 1012 “P” associated with a desired file in the widget screen 1010 may prompt a desired app to be started in conjunction with the selection of the desired file. Note that the user may press the “+” button 1014 to add an app button 1012 corresponding to an app that has not been previously used in association with a file.

<<Starting App from Widget Screen>>

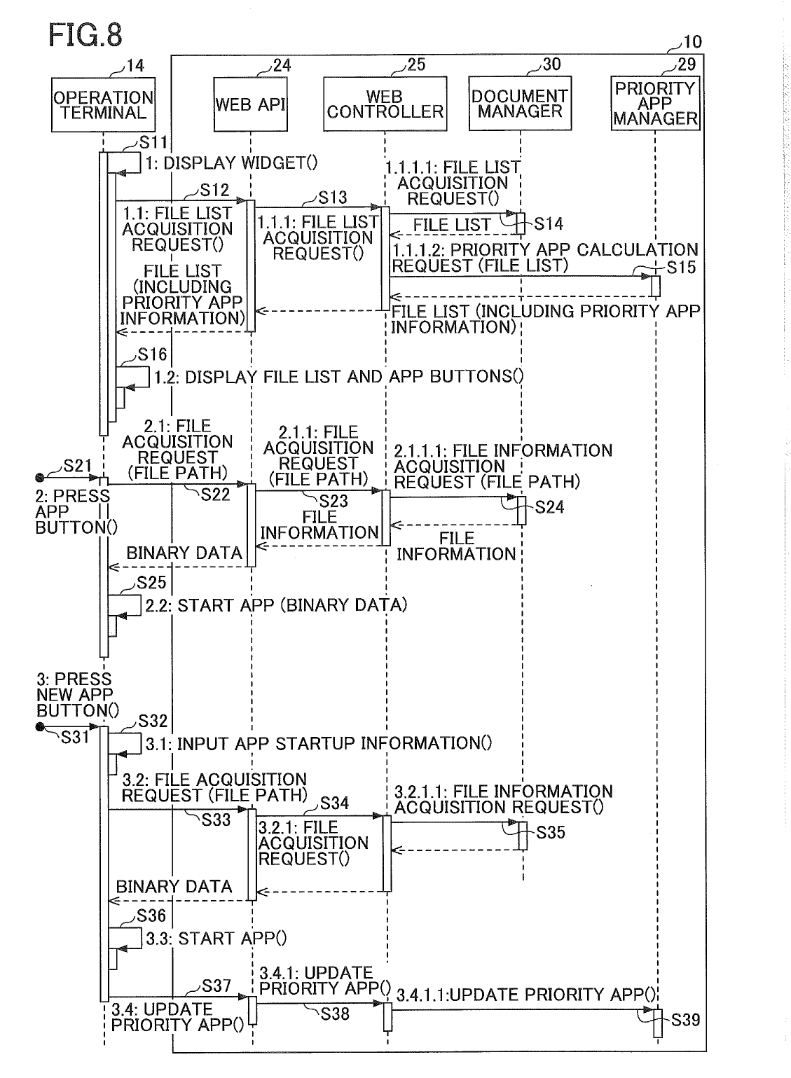

FIG. 8 is a flowchart illustrating an exemplary process for starting an app from the widget screen 1010.

In step S11, the widget installed in the operation terminal 14 starts a process for displaying the widget screen 1010.

In step S12, the file list acquiring unit 44 of the operation terminal 14 sends a file list acquisition request to the web API 24 of the information storage apparatus 10. In step S13, the web API 24 sends the file list acquisition request to the web controller 25.

In step S14, the web controller 25 sends the file list acquisition request to the document manager 30 and acquires file list information from the document manager 30. For example, the web controller 25 may acquire file list information of shared files or personal files of the user operating the operation terminal 14.

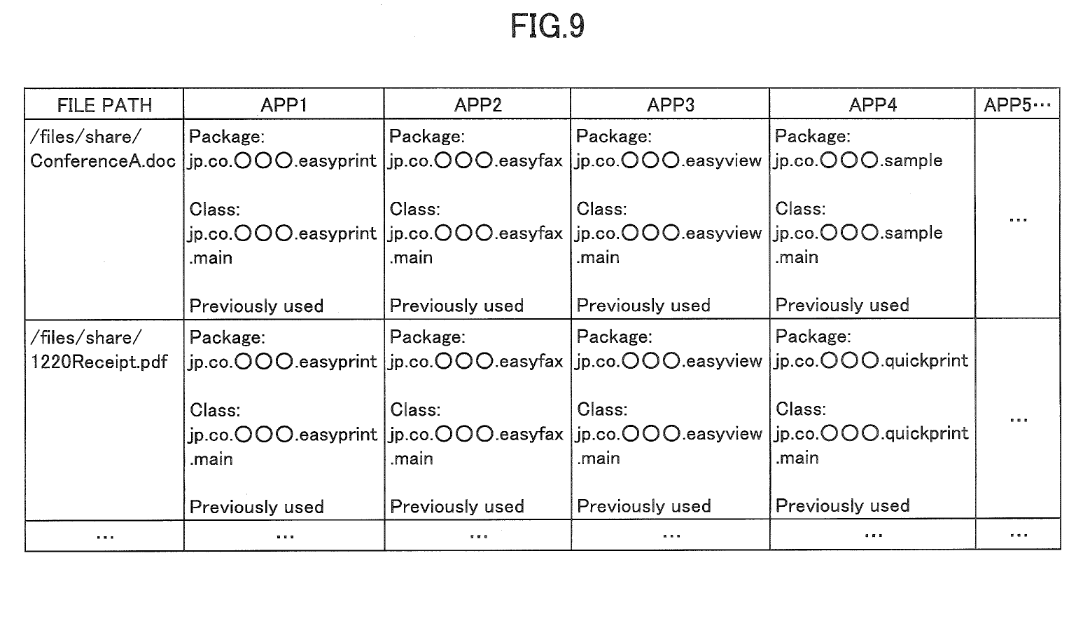

In step S15, the web controller 25 designates the file list information acquired in step S14 and sends a priority app calculation request to the priority app manager 29. The priority app manager 29 selects priority apps for the designated file list information based on priority app management information as illustrated in FIG. 9, for example.

FIG. 9 is a table illustrating an exemplary configuration of the priority application management information. The priority application management information illustrated in FIG. 9 includes a file path that unambiguously identifies a specific file and app information of each app associated with the specific file such as usage information and startup information, for example. Note that startup information may include a package name and a class name for identifying the app, for example.

The priority app manager 29 refers to the priority application management information of FIG. 9, and selects an app that has previously been used with respect to each file included in the designated file list information as a priority app.

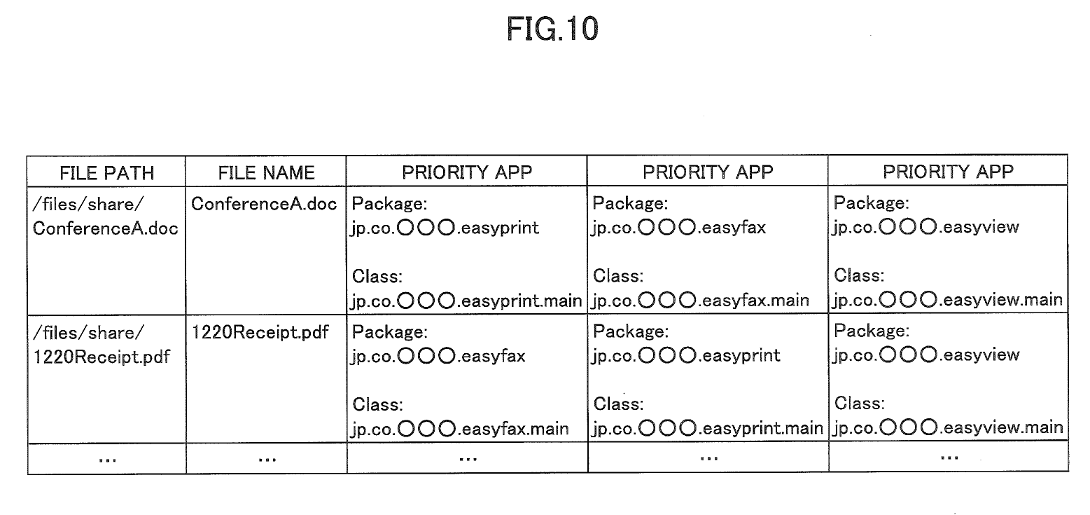

The priority app manager 29 generates file list information such as that illustrated in FIG. 10. The generated file list information includes priority app information of priority apps selected for each file included in the designated file list information. The priority app manager 29 returns the generated file list information with the priority app information to the web controller 25.

FIG. 10 is a table illustrating an exemplary configuration of the file list information including the priority app information. The file list information illustrated in FIG. 10 includes the file path and file name of each file, and priority app information of priority apps that have previously been used in association with each file. The file path indicates the location of the file. Note that in some configurations, the file list information of FIG. 10 may include icon data for displaying icons corresponding to the priority apps, for example.

The web controller 25 returns the file list information of FIG. 10 to the operation terminal 14 via the web API 24. In step S16, the display unit 41 of the operation terminal 14 displays the operation screen 1000 including the widget screen 1010 as illustrated in FIG. 7, for example, using the file list information of FIG. 10.

In step S21, the user presses an app button 1012 corresponding to a desired app to be started from the app buttons 1012 displayed in the widget screen 1010.

In step S22, the file acquiring unit 45 of the operation terminal 14 designates a file path and sends a file acquisition request to the web API 24 of the information storage apparatus 10. In step S23, the web API 24 sends the file acquisition request to the web controller 25.

In step S24, the web controller 25 sends the file information acquisition request to the document manager 30 and acquires the requested file information from the document manager 30. The web controller 25 returns the acquired file information to the web API 24. The web API 24 returns binary data of the file based on the acquired file information to the operation terminal 14. In step S25, the app starting unit 46 of the operation terminal 14 designates the acquired binary data and starts the app corresponding to the app button 1012 pressed by the user in step S21.

Note that in a case where an app button 1012 corresponding to an app that the user wishes to start in association with a desired file is not included in the app buttons 1012 displayed in association with the desired file, the user may press the “+” button 1014 displayed in association with the desired file. In turn, the display unit 41 may display a list of apps registered in the operation terminal 14 including apps that have never been used in association with the desired file and prompt the user to select an app he/she wishes to start from the displayed list of apps, for example.

When the app the user wishes to start is selected, the file acquiring unit 45 of the operation terminal 14 performs steps S33-S35 in a manner similar to the process steps S22-S24 to acquire binary data of the desired file.

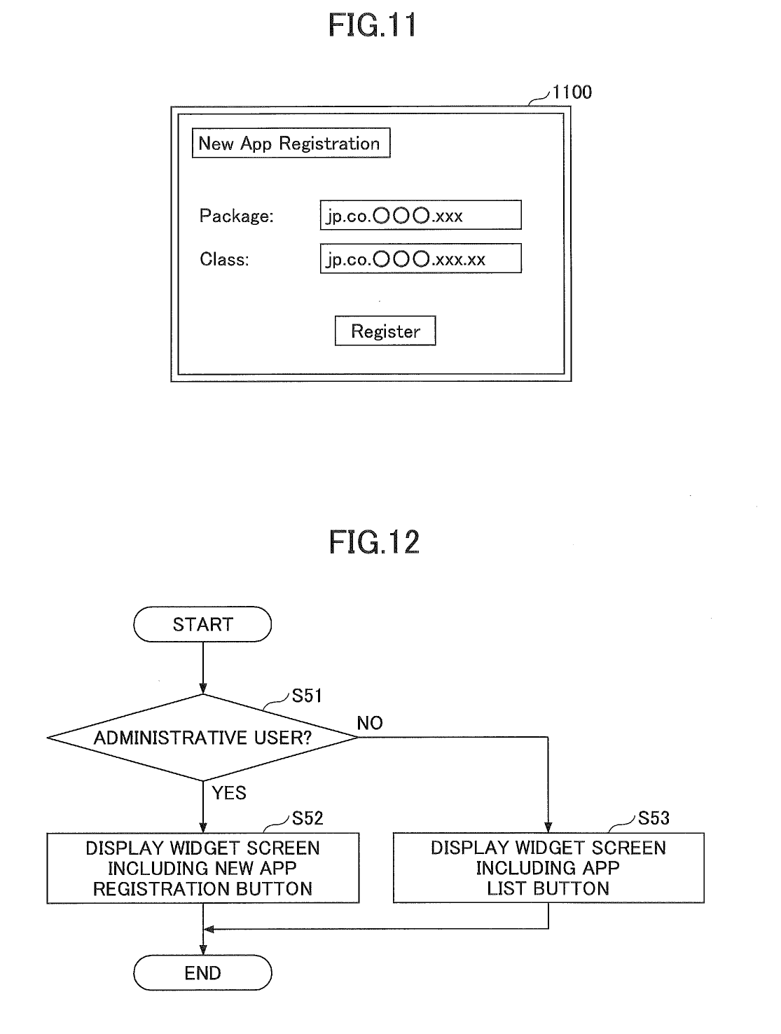

On the other hand, in a case where an app the user wishes to start is not included in the list of apps registered in the operation terminal 14, in step S31, the user may press a new app button (not shown), for example. When the new app button is pressed, in step S32, the display unit 41 of the operation terminal 14 may display a new app registration screen 1100 as illustrated in FIG. 11, for example.

FIG. 11 illustrates an example of a new app registration screen. The new application registration screen 1100 of FIG. 11 includes input fields for entering a package name and a class name (as an example of app startup information) for starting the app to be newly registered in the widget screen 1010, and a “register” button.

When the package name and class name for starting the app to be registered are entered in the new app registration screen 1100 and the “register” button is pressed thereafter, the file acquiring unit 45 of the operation terminal 14 acquires binary data in steps S33-S35 by performing processes similar to steps S22-S24 described above.

In step S36, the app starting unit 46 of the operation terminal 14 designates the acquired binary data and starts the newly registered app. In step S37, the setting manager 43 of the operation terminal 14 sends a priority app update request to the web API 24 in order to update the priority app management information of FIG. 9 by adding app information on the app started in step S36.

In step S38, the web API 24 sends the priority app update request to the web controller 25. In step S39, the web controller 25 sends the priority app update request to the priority app manager 29, and the priority app manager 29 updates the priority app management information of FIG. 9 by adding the app information on the app started in step S36.

Note that in some embodiments, the display unit 41 of the operation terminal 14 may be configured to switch the display of the widget screen 1010 included in the operation screen 1000 depending on whether the user operating the operation terminal 14 corresponds to an administrative user as illustrated in FIG. 12, for example. FIG. 12 is a flowchart illustrating an exemplary process for switching the widget screen 1010 in the operation screen 1000.

In step S51, the display unit 41 determines whether the user operating the operation terminal 14 corresponds to an administrative user. If the user operating the operation terminal 14 corresponds to an administrative user, in step S52, the display unit 41 displays the operation screen 1000 as illustrated in FIG. 7. In this way, the administrative user may be able to register a new app from the new app registration screen 1100 as illustrated in FIG. 11, for example.

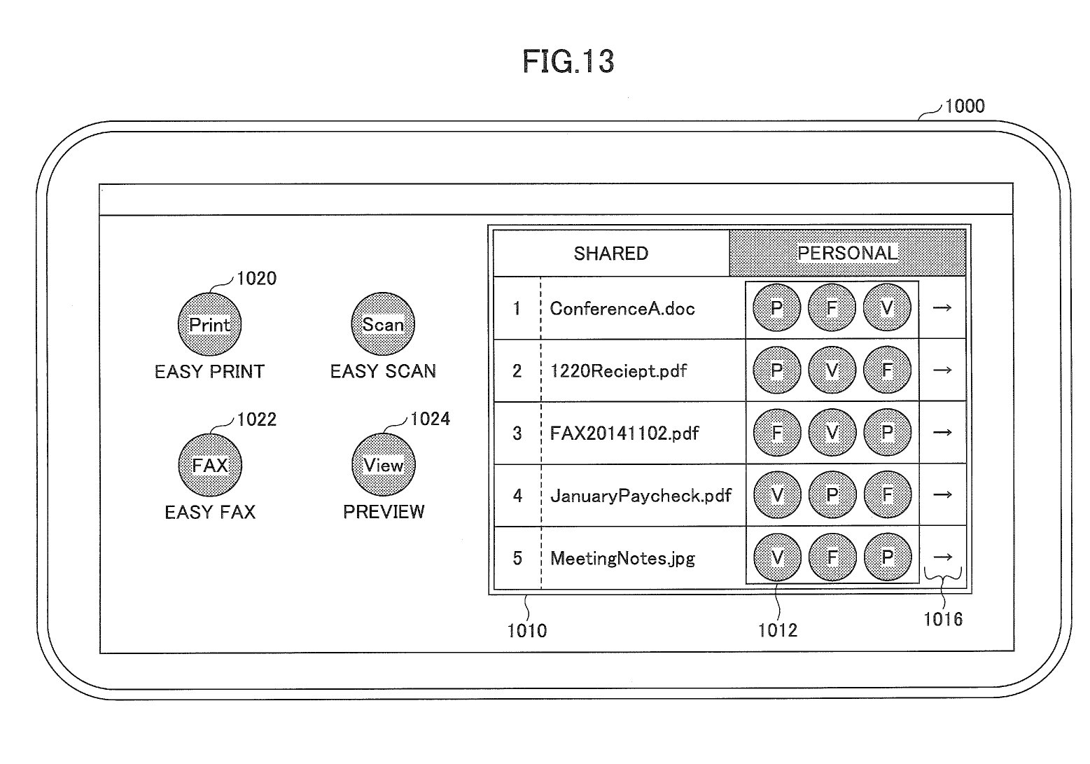

On the other hand, if the user operating the operation terminal 14 does not correspond to an administrative user, in step S53, the display unit 41 displays another version of the operation screen 1000 as illustrated in FIG. 13. FIG. 13 illustrates another example of the operation screen 1000 displayed by the operation terminal 14.

The operation screen 1000 of FIG. 13 differs from the operation screen 1000 of FIG. 7 in that it displays “→” buttons 1016 instead of the “+” buttons 1014 of FIG. 7. A general user other than an administrative user may press the “→” button 1016 to prompt the display of the list of apps registered in the operation terminal 14 so that the user may select an app to be started from the displayed list of apps. However, the general user may not be able to prompt the display of the new app registration screen 1100 as illustrated in FIG. 11. In this way, according to some preferred embodiments, the widget of the operation terminal 14 may be configured to only allow an administrative user to register a new app.

In the information processing system 1 according to the first embodiment, the widget screen 1010, which is arranged in the operation screen 1000 corresponding to a user interface of the operation terminal 14, is configured to communicate with the information storage apparatus 10 to acquire a file list. In turn, the information storage apparatus 10 returns a file list that lists files in descending order (newest to oldest) according to their update date/time. Also, the information storage apparatus 10 provides priority app information of priority apps as illustrated in FIG. 10 in association with the file list and returns the file list with the priority app information to the operation terminal 14.

Accordingly, the operation terminal 14 may be able to display the operation screen 1000 including the widget screen 1010 as illustrated in FIG. 7, for example. By pressing the app button 1012 displayed in association with a file corresponding to an app previously used in association with the file, the user may be able to select the app to be started and the file to be accessed at once.

According to an aspect of the first embodiment, a user may easily select a desired file stored in the information storage apparatus 10 and start a desired app in conjunction with the selection of the desired file.

### Second Embodiment

The widget screen 1010 according to the first embodiment displays app buttons 1012 corresponding to apps that have previously been used in association with a file. According to a second embodiment of the present invention, an order of priority of the apps is determined based on the usage frequency of the apps, and the display modes of the app buttons 1012 are changed according to the order of priority. For example, an app that is used more frequently may be given higher priority and its display mode may be changed accordingly.

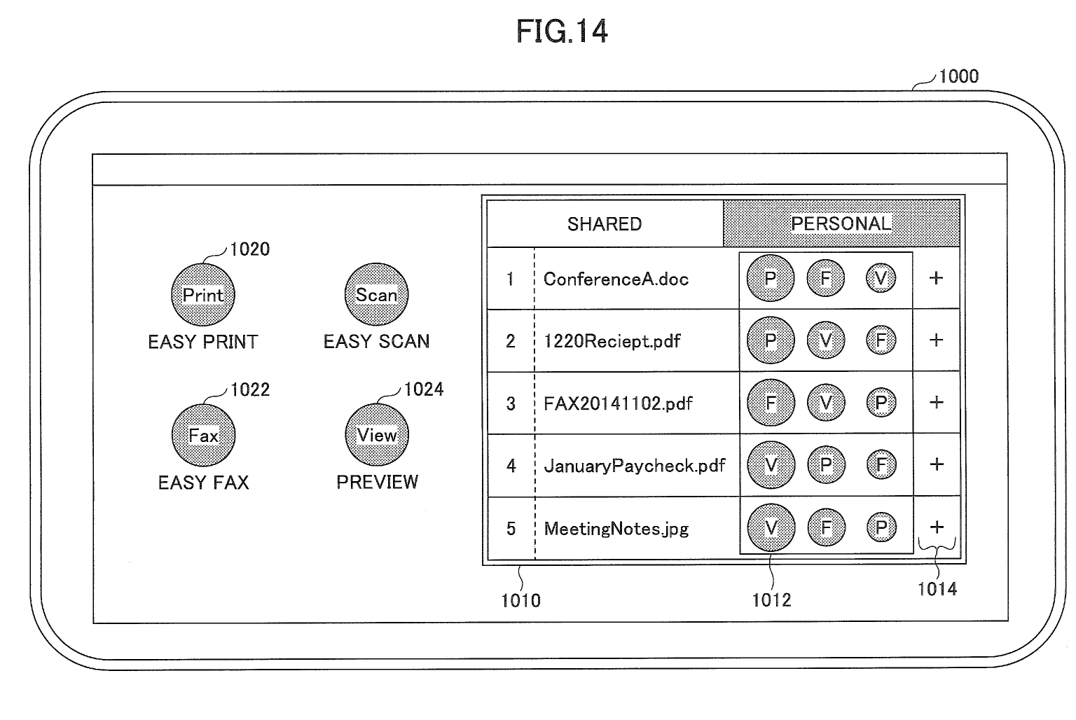

FIG. 14 illustrates another example of the operation screen 1000 displayed by the operation terminal 14. The operation screen 1000 illustrated in FIG. 14 differs from the operation screen 1000 illustrated in FIG. 7 in that the app buttons 1012 are displayed in different sizes. That is, in the widget screen 1010 of FIG. 14, the order of priority of the apps associated with each file is indicated by the size of the app buttons 1012.

For example, in the widget screen 1010 of FIG. 14, an app button 1012 corresponding to an app with higher priority is displayed larger, and an app button 1012 corresponding to an app with lower priority is displayed smaller.

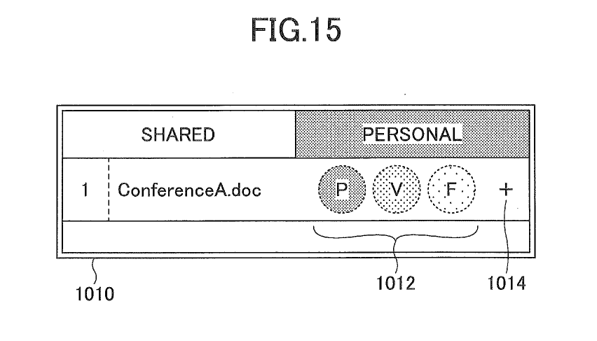

Note that although the order of priority of the apps are indicated by the size of the app buttons 1012 in the widget screen 1010 of FIG. 14, the order of priority of the apps may also be indicated by the gray level of the app buttons 1012 as illustrated in FIG. 15, for example. FIG. 15 illustrates another example of changing the display mode of the app buttons 1012 of the widget screen 1010. In the example of FIG. 15, an app button 1012 corresponding to an app with higher priority is displayed darker, and an app 1012 corresponding to an app with lower priority is displayed lighter.

Note that in other examples, the order of priority of the apps may be indicated by the position of the corresponding app buttons 1012 displayed in the widget screen 1010 of FIG. 7 or FIG. 13. For example, in the widget screen 1010 of FIG. 7 or FIG. 13, an app button 1012 corresponding to an app with higher priority may be displayed toward the left side, and an app button 1012 corresponding to an app with lower priority may be displayed toward the right side.

<<Starting App from Widget Screen>>

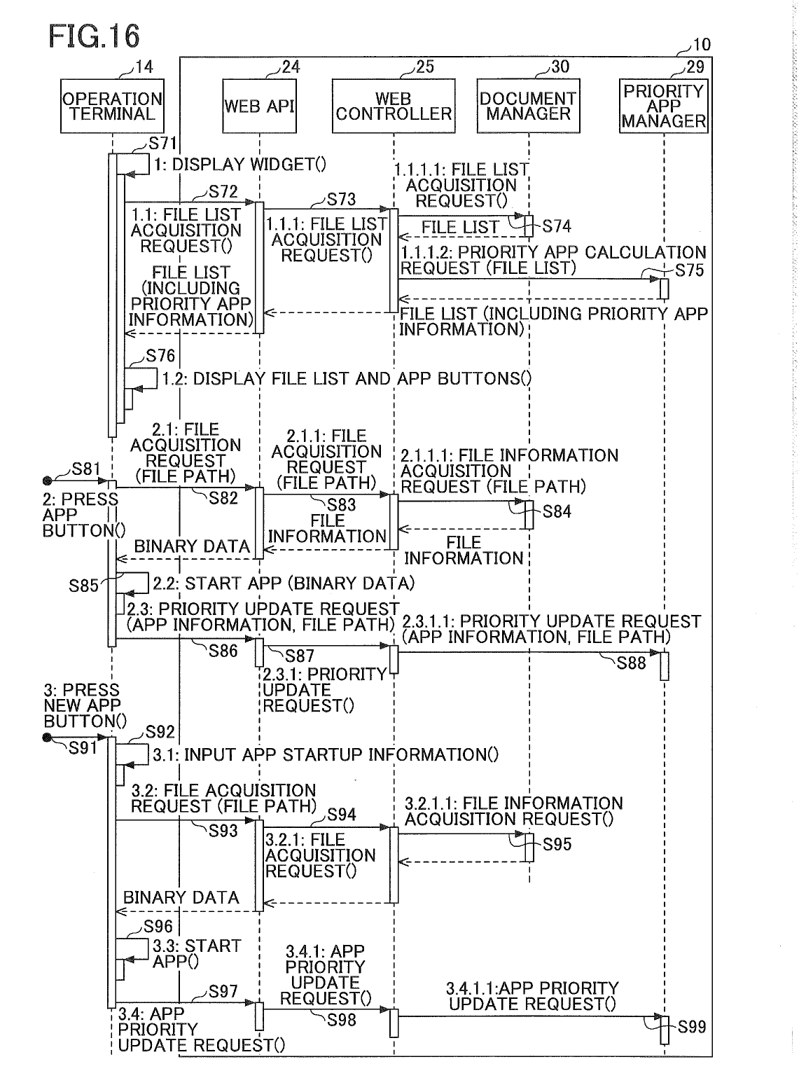

In the second embodiment, an app may be started from the widget screen 1010 by executing process steps as illustrated in FIG. 16, for example. FIG. 16 is a flowchart illustrating another exemplary process for starting an app from the widget screen 1010. Note that some of the process steps included in the flowchart of FIG. 16 may be substantially identical to the process steps of FIG. 8, and as such, descriptions of such process steps may be omitted as is appropriate.

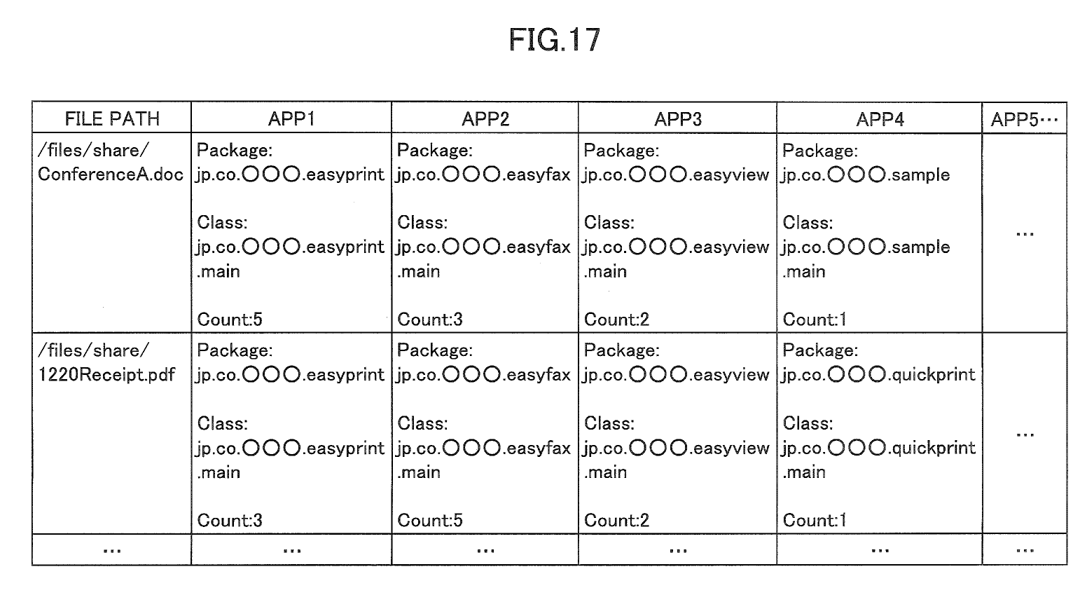

The processes of steps S71-S74 of FIG. 16 may be substantially identical to steps S11-S14 of FIG. 8, and as such, descriptions thereof will be omitted. In step S75 of FIG. 16, the web controller 25 designates the file list information acquired in step S74, and sends a priority app calculation request to the priority app manager 29. In turn, the priority app manager 29 selects priority apps for the files included in the designated file list information from priority app management information as illustrated in FIG. 17, for example.

FIG. 17 is a table illustrating another exemplary configuration of the priority app management information. The priority app management information of FIG. 17 includes the file path of each file, and startup information and a count value indicating the usage frequency of each app with respect to each file path.

The priority app manager 29 refers to the priority app management information of FIG. 17, and determines the order of priority of the apps with respect to each file included in the designated file list information based on the usage frequency of the apps. For example, the priority app manager 29 may determine first through third priority apps for each file included in the designated file list information based on the determined order of priority of the apps.

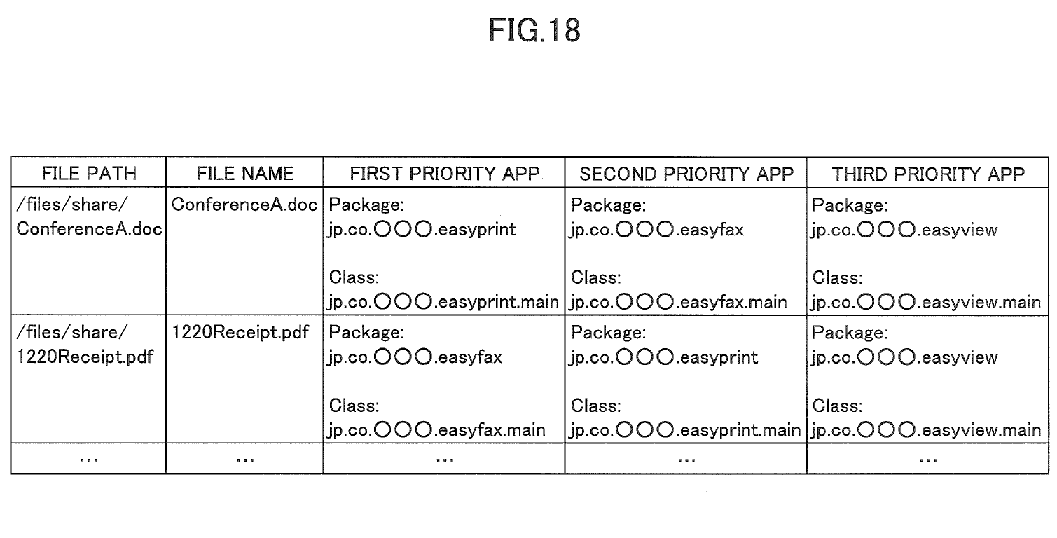

The priority app manager 29 generates file list information including first through third priority app information of the first through third priority apps as illustrated in FIG. 18, and returns the generated file list information to the web controller 25. FIG. 18 is a table illustrating an exemplary configuration of file list information including the first through third priority app information. The file list information illustrated in FIG. 18 stores the file path and the file name of each file in association with the corresponding first through third priority app information.

The web controller 25 returns the file list information of FIG. 18 to the operation terminal 14 via the web API 24. In step S76, the display unit 41 of the operation terminal 14 displays the operation screen 1000 including the widget screen 1010 as illustrated in FIG. 14 or 15 using the file list information of FIG. 18, for example.

The processes of steps S81-S85 of FIG. 16 may be substantially identical to those of steps S21-S25 of FIG. 8, and as such, descriptions thereof will be omitted. In step S86, the setting managing unit 43 of the operation terminal 14 sends a priority update request to the web API 24 to update the count value for the app that was started in step S85 in the priority app management information of FIG. 17.

In step S87, the web API 24 sends the priority update request to the web controller 25. In step S88, the web controller 25 sends the priority update request to the priority app manager 29, and updates the priority app management information of FIG. 17 by adding “1” to the count value for the app that was started in step S85.

The processes of steps S91-S95 of FIG. 16 may be substantially identical to those of steps S31-S35 of FIG. 8, and as such, descriptions thereof will be omitted. In step S96, the app starting unit 46 of the operation terminal 14 designates the binary data acquired in the preceding steps, and starts the newly registered app. The priority updating processes of steps S97-S99 may be identical to those of steps S86-S88 described above, and as such, descriptions thereof will be omitted.

In the information processing system 1 according to the second embodiment, the widget screen 1010, which is arranged in the operation screen 1000 corresponding to the user interface of the operation terminal 14, communicates with the information storage apparatus 10 to acquire a file list. At this time, the information storage apparatus 10 returns a file list including files arranged in descending order (newest to oldest) according to their update date/time. Also, priority app information of priority apps that are assigned an order of priority is associated with the file list returned by the information storage apparatus 10.

Thus, the operation terminal 14 may display the operation screen 1000 including the widget screen 1010 as illustrated in FIG. 14 or 15, for example. In turn, the user of the operation terminal 14 may select a combination of a desired file and a priority app that is frequently used with the desired file in one operation by pressing the app button 1012 corresponding to the priority app displayed in association with the desired file.

According to an aspect of the second embodiment, a user may easily select a desired file stored in the information storage apparatus 10 and start a desired app in conjunction with the selection of the desired file.

### Third Embodiment

In the first and second embodiments described above, priority apps are selected based on the usage track record or the usage frequency of apps in association with each file. According to a third embodiment of the present invention, information such as priority app management information and priority app information for a file that is newly stored in the information storage apparatus 10 are estimated and prepared in advance.

For example, with respect to a file that is newly stored in the information storage apparatus 10, the setting managing unit 43 of the operation terminal 14 may estimate an app (priority app) that is likely to be executed in conjunction with the selection of the file based on the extension of the newly stored file and associate the estimated priority app with the file.

Also, the setting managing unit 43 of the operation terminal 14 may estimate an app (priority app) that is likely to be executed in conjunction with the selection of a file that is newly stored in the information storage apparatus 10 based on a file input method (e.g., receiving by fax, SD card scanning) of the newly stored file and associate the estimated priority app with the file.

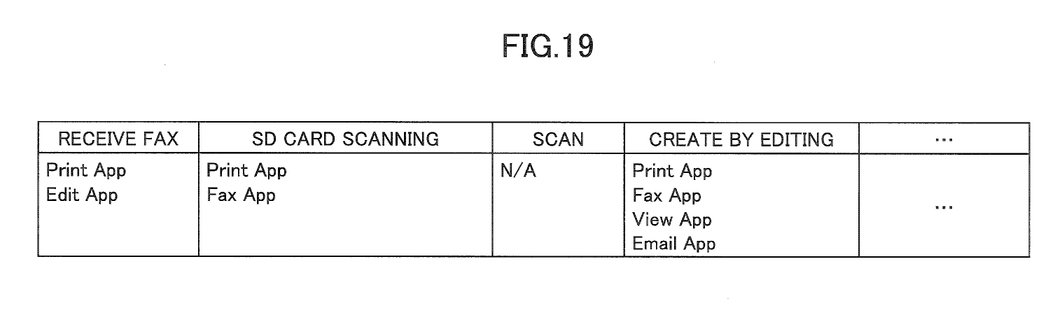

FIG. 19 is a table associating exemplary file input methods with relevant apps. In the table of FIG. 19, “receive fax”, “SD card scanning”, “scan”, and “create by editing” are indicated as exemplary file input methods. By using the table of FIG. 19, the setting management unit 43 of the operation terminal 14 may estimate an app (priority app) that is likely to be executed in conjunction with a file that is newly stored in the information storage apparatus 10 based on the file input method of the newly stored file. Note that in other examples, a priority app for a file may be estimated based on a file processing method (e.g. editing method) of the file and the estimated priority app may be associated with the file.

According to an aspect of the third embodiment, information such as priority app management information and priority app information for a file that is newly stored in the information storage apparatus 10 may be estimated and prepared in advance.

Although the present invention has been described above with respect to certain illustrative embodiments, the present invention is not limited to these embodiments and various changes and modifications may be made without departing from the scope of the present invention. For example, in the above-described embodiments, the priority apps for files included in the file list information are selected at the information storage apparatus 10. However, in other examples, the priority app management information may be sent to the operation terminal 14, and the operation terminal 14 may select the priority apps for each of the files included in the file list information based on the priority app management information.

Note that the file list acquiring unit 44 is an example of an electronic data list acquiring unit according to the present invention. The display unit 41 is an example of a display unit according to the present invention. The app starting unit 46 is an example of a starting unit according to the present invention. The app button 1012 is an example of a startup accepting unit according to the present invention. Also, a file in the above-described embodiments is an exemplary form of electronic data.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device. The non-transitory storage medium can comprise any computer-readable medium except for a transitory, propagating signal.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Application No. 2015-012560 filed on Jan. 26, 2015, the entire contents of which are hereby incorporated by reference.

What is claimed is:

1. An operation terminal having a plurality of applications installed therein and being configured to start an application that has been selected by a user from among the plurality of applications, the operation terminal comprising:
an electronic data list acquiring unit configured to acquire, from an information storage apparatus, a list of electronic data items stored in the information storage apparatus and priority application information of a priority application associated with each of the electronic data items included in the list;
a display unit configured to display, based on the list of electronic data items and the priority application information acquired by the electronic data list acquiring unit, an operation screen including the list of electronic data items and a startup accepting unit provided with respect to each of the electronic data items included in the list, the startup accepting unit being configured to accept from the user a startup request for starting the priority application that is associated with a relevant electronic data item of the electronic data items included in the list; and
a starting unit configured to select the relevant electronic data item that is associated with the priority application for which the startup request has been accepted from the user by the startup accepting unit and start the priority application.

2. The operation terminal according to claim 1, wherein
the electronic data list acquiring unit acquires, from the information storage apparatus, the priority application information of the priority application that is selected from the plurality of applications based on a usage track record of each of the plurality of applications with respect to each of the electronic data items included in the list.

3. The operation terminal according to claim 2, wherein
the display unit displays in the operation screen, the startup accepting unit for accepting from the user the startup request for starting the priority application that has previously been used with respect to each of the electronic data items.

4. The operation terminal according to claim 1, wherein
the electronic data list acquiring unit acquires from the information storage apparatus the priority application information of the priority application that is selected from the plurality of applications based on a usage frequency of each of the plurality of applications with respect to each of the electronic data items included in the list.

5. The operation terminal according to claim 4, wherein
the display unit displays in the operation screen, the startup accepting unit for accepting from the user the startup request for starting the priority application that has a high usage frequency with respect to each of the electronic data items.

6. The operation terminal according to claim 5, wherein the display unit changes a display mode of the startup accepting unit according to the usage frequency of the priority application.

7. The operation terminal according to claim 6, wherein the display unit changes the display mode of the startup accepting unit by changing at least one of a size and a gray level of the startup accepting unit displayed in the operation screen.

8. The operation terminal according to claim 1, wherein the display unit displays the startup accepting unit in the operation screen as a display component visually representing the priority application.

9. A non-transitory computer-readable medium having a computer program recorded thereon that is executable by an operation terminal having a plurality of applications installed therein and being configured to start an application that has been selected by a user from among the plurality of applications, the computer program when executed causing the operation terminal to perform the steps of:
acquiring, from an information storage apparatus, a list of electronic data items stored in the information storage apparatus and priority application information of a priority application associated with each of the electronic data items included in the list;
displaying, based on the acquired list of electronic data items and the acquired priority application information, an operation screen including the list of electronic data items and a startup accepting unit provided with respect to each of the electronic data items included in the list, the startup accepting unit being configured to accept from the user a startup request for starting the priority application that is associated with a relevant electronic data item of the electronic data items included in the list; and
selecting the relevant electronic data item that is associated with the priority application for which the startup request has been accepted from the user by the startup accepting unit and starting the priority application.

10. An information processing system comprising:
an information storage apparatus configured to store electronic data; and
an operation terminal having a plurality of applications installed therein and being configured to start an application that has been selected by a user from among the plurality of applications;
wherein the operation terminal includes
an electronic data list acquiring unit configured to acquire from the information storage apparatus, a list of electronic data items stored in the information storage apparatus and priority application information of a priority application associated with each of the electronic data items included in the list;
a display unit configured to display, based on the list of electronic data items and the priority application information acquired by the electronic data list acquiring unit, an operation screen including the list of electronic data items and a startup accepting unit provided with respect to each of the electronic data items included in the list, the startup accepting unit being configured to accept from the user a startup request for starting the priority application that is associated with a relevant electronic data item of the electronic data items included in the list; and
a starting unit configured to select the relevant electronic data item that is associated with the priority application for which the startup request has been accepted from the user by the startup accepting unit and start the priority application.
